(19) United States
(12) Patent Application Publication
(10) Pub. No.: US 2009/0201862 A1
(43) Pub. Date: Aug. 13, 2009

(54) Co-existence between communications units

(76) Inventors: Jani Petri Okker, Tampere (FI); Ville Vesa Pernu, Tampere (FI); Jussi Ilmari Ylanen, Lempaala (FI)

Correspondence Address: SQUIRE, SANDERS & DEMPSEY L.L.P., 8000 TOWERS CRESCENT DRIVE, 14TH FLOOR, VIENNA, VA, 22182-6212, US

(21) Appl. No.: 12/155,217

(22) Filed: May 30, 2008

(30) Foreign Application Priority Data
Feb. 8, 2008 (FI) 20085109

(51) Int. Cl. H04W 72/00; H04B 7/00

(52) U.S. Cl. 370/329; 455/70

(57) ABSTRACT

The present invention relates to a method for arranging co-existence between wireless devices, comprising: checking the priority class for a data service flow transmitted or received by a first communications unit, generating a priority signal for a second communications unit to indicate prioritization for the first communications unit on the basis of the checking, and adapting transmission and/or reception of the second communications unit in response to the priority signal.

### FIELD OF THE INVENTION

The invention relates to arranging co-existence between communications units.

### BACKGROUND OF THE INVENTION

Current digital mobile communication devices include a number of radio units. In some multi-radio terminals there needs to be means to control band usage to avoid disruptions to the performance of the device due to self-inflicted interference. Particularly, when two or more devices operate in the same frequency band, there is mutual interference between the two wireless systems, which may result in severe performance degradation. Hardware techniques, isolation or filtering may be applied to reduce interference.

IEEE has specified practises to enhance co-existence between a wireless local area network (WLAN) specified in IEEE 802.11 and personal area networks (PAN), such as Bluetooth, specified in IEEE 802.15. These techniques apply the 2.4 GHz unlicenced band.

However, interference reduction measures may need to be taken also for radios operating in a band close to the band of another radio. For instance, one of the operating frequency bands (2.5 GHz) of a mobile WiMAX specified in IEEE802.16e is next to the 2.4 GHz ISM band. These frequency bands are so close to each other that transmissions on one band will cause interference to the transmission and reception of the other band. In a mobile device comprising two transceivers, one of the transceivers may signal to the other transceiver of transmission or reception activity, whereby the other transceiver may refrain from transmitting or receiving. However, there is a need to further develop co-existence awareness.

### SUMMARY OF THE INVENTION

A method, apparatuses, a computer program product, and a multi-radio controller are now provided, which are characterized by what is stated in the independent claims. Some embodiments of the invention are described in the dependent claims.

According to an aspect of the invention, a method is provided for arranging co-existence between communications units for wireless communications. In accordance with the method, a priority class is checked for a data service flow transmitted or received by a first communications unit. A priority signal is generated for a second communications unit on the basis of the checking, to indicate prioritization for the first communications unit. Transmission and/or reception of the second communications unit is adapted in response to the priority signal.

The invention and various embodiments of the invention provide several advantages, which will become apparent from the detailed description below. One advantage is that prioritization may be arranged for certain data service flows and it becomes possible to have data service flow specific prioritization.

### BRIEF DESCRIPTION OF THE DRAWINGS

Embodiments of the present invention are described below, by way of example only, with reference to the accompanying drawings, in which

FIG. 1 illustrates an apparatus according to an embodiment;

FIG. 1A illustrates a multi-radio controller according to an embodiment;

FIG. 2 illustrates an apparatus according to an embodiment;

FIG. 3 illustrates a method according to an embodiment;

FIG. 4 illustrates a method according to an embodiment;

FIG. 5 illustrates a transmission example according to an embodiment; and

FIG. 6 illustrates an implementation example according to an embodiment.

### DETAILED DESCRIPTION OF PREFERRED EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

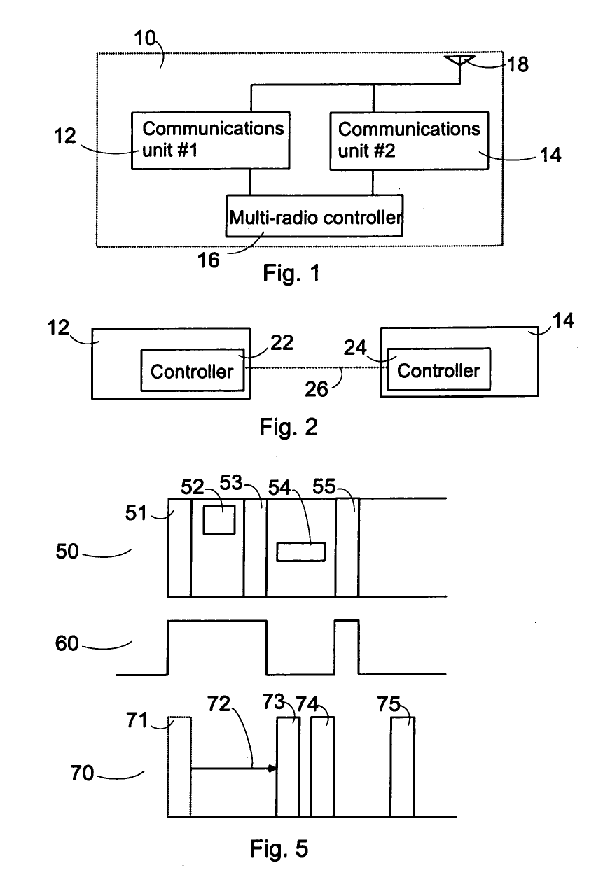

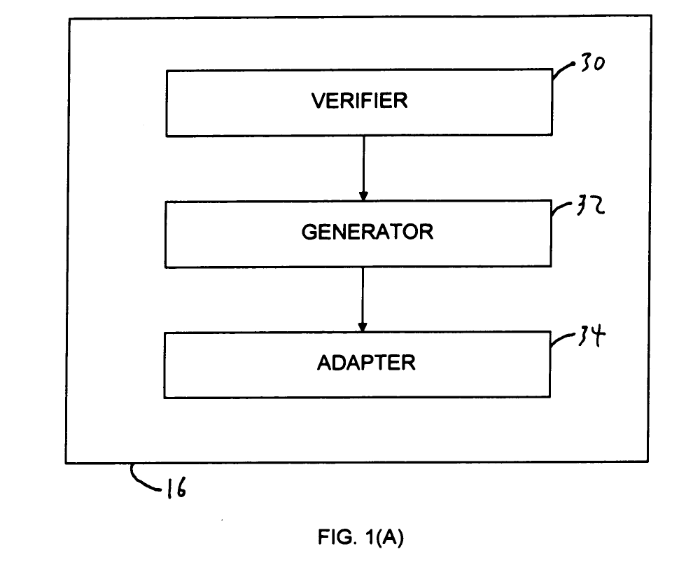

FIG. 1 illustrates a simplified block diagram of an apparatus 10 according to an embodiment. The apparatus 10 comprises a first wireless communications unit 12, a second wireless communications unit 14 and a multi-radio controller 16 for controlling co-existence between the units 12 and 14. The units 12 and 14 are connected to an antenna 18. It is to be noted that in an alternative embodiment the units 12 and 14 are connected to separate antennas. The communications units 12, 14 may even be located in separate or separable devices.

The controller 16 is arranged to control co-existence between the units 12 and 14 by prioritizing one or more data service flows to be transmitted or received by a communications unit 12, 14. The controller 16 may check a priority class for a data service flow to be transmitted or received by one of the communications units 12, 14, hereafter referred to as the first communication unit. On the basis of the checking, the controller 16 selectively generates a priority signal for the other communications unit, hereafter the second communications unit, to indicate prioritization for the first communications unit. In response to the priority signal, the second communications unit is configured to adapt transmission and/or reception. In one embodiment the transmission and/or reception is delayed until the end of the priority signal indicating high priority.

Although the apparatus 10 has been depicted as one entity, different modules and memory may be implemented in one or more physical or logical entities. Although the units are separated in FIG. 1, these functions could be implemented at least partially in a single module or device.

The multi-radio controller may be a single physical entity operationally connectable to the communications units 12, 14. Such multi-radio controller apparatus may be a chipset, for instance. The chipset or integrated circuit may be suitable for use in a mobile phone or a portable computer, for instance. The co-existence control functionalities may be implemented at the apparatus by software, by hardware or a combination of these. In the following, for simplicity, the apparatus refers to the apparatus 10 illustrated in FIG. 1.

FIG. 1A illustrates a block diagram of the multi-radio controller 16 according to an embodiment. The multi-radio controller 16 includes a verifier 30 configured to check a priority class for a data service flow transmitted or received by the first communications unit 12. A generator 32 in the multi-radio controller 16 selectively generates a priority signal for the second communications unit 14 on the basis of the checking by the verifier 30. An adapter 34 in the multi-radio controller 16 adapts at least one of transmission and reception by the second communications unit 14 in response to the priority signal generated by the generator 32.

The priority signal generated by the generator 32 may indicate a low priority in response to the generator 32 detecting that there is no traffic scheduled or in response to a scheduled data service flow belonging to a priority class for non-delay sensitive traffic. The second communications unit 14 may perform at least one of transmitting and receiving in response to receiving the priority signal from the generator 32 indicating low priority.

The verifier 30 may define connections for link establishment as high priority data service flows. The generator 32 may also generate the priority signal for the second communications unit 14 to prevent transmission by the second communications unit 14 during these defined connections. The generator 32 may also generate the priority signal so as to prevent transmission by the second communications unit 14 for reception of WiMAX downlink maps, uplink maps, downlink channel descriptor fields and uplink channel descriptor fields.

The verifier 30 may switch the priority signal to indicate low priority after the reception of the link establishment and service flow connection data and in response to no data or no high-priority data being scheduled for the data service flow. The verifier 30 may further check a connection identifier of each packet to be transmitted in a single data frame and define a priority class for each of the connection identifiers. The generator 32 may generate a priority signal prioritizing transmission of the data frame in accordance with a highest priority class.

The verifier 30, generator 32 and adapter 34 may be hardware components including, for instance, an integrated circuit, a processor, a controller, input and output components, and the like. Alternatively, these components could be implemented via software, a combination of software and hardware, on a single processor or on multiple processors.

In another embodiment, instead of separate unit 16, the multi-radio controller may be arranged in one or both of the communications units 14, 16. In one embodiment the apparatus 10 comprises a prioritization controller adapted to generate the prioritization signal in the first communications unit. As illustrated in FIG. 2, the first communications unit 12 comprises a first prioritization controller 22 configured to check the priority class and to generate the priority signal 26 to the second communications unit 14. The second communications unit 14 comprises a second prioritization controller configured to receive the priority signal and adapt operation of the second communications unit in response to the priority signal. Hence, the priority signal is submitted between the communications units 12 and 14 in these embodiments.

Prioritization may be arranged also for data service flow of the second communications unit, i.e. a data service flow of the either one of the communications units 12, 14 is prioritized over a data of the other communications unit. For instance, the controllers 22 and 24 may comprise both priority signal generating and receiving functions. The data having the highest priority class may thus be prioritized.

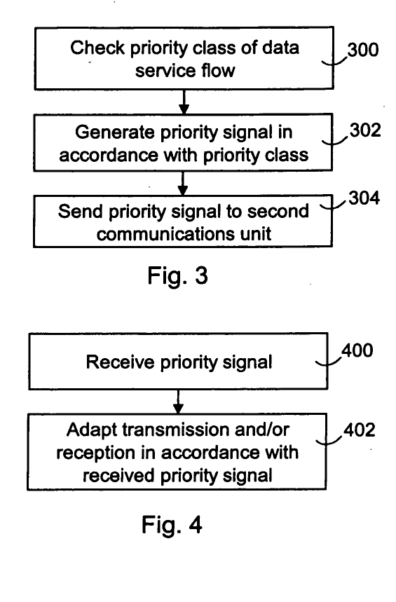

The apparatus thus comprises control means for arranging prioritization of data transmission/reception of a communications unit on the basis of a prioritization class of the data flow being transferred. In particular, means may be provided for arranging the features illustrated in connection with FIGS. 3, 4, 5, and 6. It should be appreciated that the apparatus may comprise other units, but they are irrelevant to the present embodiments and, therefore, they need not be discussed in more detail here.

The apparatus may be any communications device comprising at least two communications units capable of causing interference to another communications unit's operation. Some examples of such an apparatus include a mobile station or a mobile phone apparatus, an entertainment device, such as a game console, a laptop, a personal digital assistant, or an accessory device. The apparatus may comprise a plurality of wireless transceivers, for instance operating according to a 2G wireless communications standard, such as the GSM (Global System for Mobile Communications), according to a 3G standard, such as the WCDMA (Wideband Code Division Multiple Access), according to a 4G or further generation standard, according to a WLAN (Wireless Local Area Network), WiMAX, Bluetooth® standard, or in accordance with any other suitable standard/non-standard wireless communication means.

The apparatus or the units thereof could be in the form of a chip unit or some other kind of hardware module for controlling a communications device. Such hardware module comprises connecting means for connecting the communications device mechanically and/or functionally. Thus, the hardware module may form part of the device and could be removable. Some examples of such a hardware module are a sub-assembly or an accessory device.

The apparatus may be implemented as an electronic digital computer, which may comprise memory, a central processing unit (CPU), and a system clock. The CPU may comprise a set of registers, an arithmetic logic unit, and a control unit. The control unit is controlled by a sequence of program instructions transferred to the CPU from the memory. The control unit may contain a number of microinstructions for basic operations. The implementation of microinstructions may vary, depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment provides a computer program embodied on a distribution medium, comprising program instructions which, when loaded into an electronic apparatus, constitute the prioritization controller(s) 16, 22, 24. The computer program may be in source code form, object code form, or in some intermediate form, and it may be stored in some sort of data storage medium or carrier, which may be any entity or device capable of carrying the program.

At least some functions of the apparatus 10 or the prioritization controller(s) 16, 22, 24 may also be implemented as one or more integrated circuits, such as application-specific integrated circuits ASIC. Other hardware embodiments are also feasible, such as a circuit built of separate logic components. A hybrid of these different implementations is also feasible. Some co-existence control embodiments are now described in further detail below in connection with FIGS. 3, 4, 5, and 6.

FIG. 3 illustrates a method according to an embodiment. In step 300, in response to a need to transmit or receive data, the priority class of a data service flow for data to be transmitted or received is checked. In step 302 a priority signal is generated in accordance with the priority class of the data service flow. In step 304 the priority signal is sent to the second transceiver.

FIG. 4 illustrates general procedure for controlling transmission/reception features in a communications unit receiving the priority signal, i.e. the second communications unit. In step 400 a priority signal generated in accordance with the priority class of the current data service flow of the first communications unit is received. In step 402 transmission and/or reception of the second communications unit is adapted in response to and in accordance with the priority signal. In this step the transmission or reception may be delayed for a pre-determined period or until the end of the priority signal, for instance.

The prioritization is applied data service flow specifically, i.e. each data flow may have its own priority class. A data service flow is to be understood broadly to refer to a set of data characterized by certain criteria, such as information type or destination identifier. For instance, data associated with a connection established in response to a request from an application or another communications device, or network control data, may be considered to form a data service flow. The data service flow may be a (logical) connection of a data link layer, such as logical link connection, but may also refer to a higher layer data flow.

In one embodiment each data service flow is priority tagged, indicating the priority class of the data service flow. Thus, an upper layer protocol entity may inform a lower layer protocol entity of the priority class being applied for the data service flow. This data service flow specific priority indication could be included in or associated with each packet or other data unit submitted for transmission.

In another embodiment a data flow identifier is used for defining the priority signal. The data flow identifier may be obtained from an upper layer protocol entity and used in step 300 to check the priority class. Each packet may be associated with a data flow identifier, on the basis of which the priority class is defined 300. The priority signal is then generated 302 for transmitting the packet in accordance with the priority class of the data service flow to which the packet belongs.

Information for determining an appropriate priority class for a data service flow may be stored in the apparatus and retrieved in step 300. For instance, the apparatus may store mapping information between link identifiers and priority class values for each link, and the multi-radio controller uses this mapping information in step 300.

A frame, or a sub-frame, to be transmitted may include packets or data units belonging to different data service flows. In one embodiment, the apparatus 10 or the multi-radio controller 16 is configured to check 300 the connection identifier of each packet to be transmitted in a single data frame. A priority class for each of the one or more connection identifiers is first defined and the highest priority class is selected for the entire data frame. Thus, the priority signal is generated 302 in accordance with the highest priority class to prioritize transmission of the entire data frame.

The priority class for a data service flow may be fixed or dynamically adjustable. A data service flow may include data of more than one priority class, and the priority signal for the second communications unit may be varied accordingly. The multi-radio controller may check or specify the priority class on the basis of information from the first communications unit or another source. An application may indicate the nature or priority class of the data to be transmitted/received or the service required. In one embodiment the type of the data influences or defines the priority class. For instance, a higher priority is set for retransmission of a packet. The priority class may be further changed to indicate higher priority for consecutive retransmission(s) of the packet.

The priority signal may be arranged in various ways, some of which are briefly illustrated below. The priority signal may be transmitted to indicate high-priority transmission/reception by the first communications unit, i.e. if no priority signal is received, or alternatively a priority signal for low priority is detected, the second communications unit is free to transmit/receive. In one embodiment the priority signal specifically indicates the priority class of the data being transmitted.

The number of priority classes, and also priority signal values, may be configured in accordance with application, system and implementation needs. For instance, 8 possible priority values may be available, but the number of priority values is not limited to any specific values. Different information types may be assigned with different priority values on the basis of their delay-sensitivity, for instance.

The second communications unit may be arranged to compare priority information of the first communications unit to the priority information of the second communications unit, and to allow transmission/reception for the highest priority data service flow. In an alternative embodiment, the multi-radio controller 16 compares priority class information of data service flows of the communications units in a centralized manner, and allows transmission/reception for a communications unit with the highest priority data service flow.

In one embodiment a priority signal indicating low priority is generated when there is no traffic scheduled or in response to the data scheduled for transmission or reception belonging to the priority class for non-delay sensitive traffic. The second communications unit receiving the priority signal is configured to allow transmission and/or reception in response to the priority signal indicating low priority.

In one embodiment, network control data is always prioritized by generating a priority signal to indicate high priority during reception of network control data. Such a priority signal may also be generated during transmission of important control data from the terminal to the network. In one embodiment, the priority signal indicating high priority is generated during connection or session setup or closing of related signaling.

In one embodiment, the apparatus is configured to prevent or delay transmission by the first communications unit in response to detecting a need to transmit low priority data by the first communications unit. Hence, a priority signal indicating low priority may be generated, and more space is available for transmission of the second communications unit.

In one embodiment at least some of the presently disclosed features for facilitating co-existence of multiple radios is implemented in a device comprising a WiMAX transceiver. However, it is to be noted that the application of the present embodiments is not limited to any specific radio system.

The IEEE 802.16 standard is also known as the IEEE Wireless Metropolitan Area Network, delivering performance comparable to a traditional cable or DSL (Digital Subscriber Line), and is considered to provide the “last mile” connectivity at high data rates. IEEE 802.16e, i.e. mobile WiMAX, applies OFDM (Orthogonal Frequency Division Multiplexing) technology, adaptive modulation and error correction. The 802.16 MAC uses a scheduling algorithm for which the subscriber station needs to compete once (for initial entry into the network), after which it is allocated an access slot by a base station. The time slot can enlarge and contract, but remains assigned to the subscriber station, which means that other subscribers cannot use it. The scheduling algorithm also allows the base station to control QoS parameters by balancing the time-slot assignments among the application needs of the subscriber stations.

In WiMAX the traffic is based on frames which are divided in a downlink (DL) part and an uplink (UL) part. The frame structure used in mobile WiMAX is described in FIG. 5. At the beginning of DL sub-frame there are DL/UL maps which describe how the base station has scheduled activity for service flows. What is noticeable in mobile WiMAX network is that the UL map does not describe the UL sub-frame allocations of the current frame but the frame after the current frame.

In one embodiment, each data link identified by a connection identifier (CID), or a further connection identifier taken from the CID address space, may have a specific priority class value. The priority class may be defined (300) on the basis of the CID associated with a packet to be transferred. If packets of more than one link are to be placed in a UL sub-frame, the multi-radio controller may be arranged to generate a prioritization signal for the UL sub-frame on the basis of the highest priority class.

In one embodiment, the apparatus is configured to generate the priority signal to prevent transmission by the second communications unit for reception of downlink maps and uplink maps. Further, such a priority signal may be generated during reception of the downlink channel descriptor DCD fields and uplink channel descriptor UCD fields after DL/UL map and including important parameters of the network. Thus, it is further possible to enhance correct reception and transmission of essential operational data when the WiMAX transceiver is active, i.e. not in power save mode. The reception of these fields may be prioritized by activating the priority signal.

The rest of the DL frame may be indicated to be high priority if a WiMAX base station has allocated time for any high priority service flow data reception. Similarly, the UL part of the frame may be signalled to be high priority if transmission time has been scheduled for any high priority service flow. Otherwise the priority signal may be maintained in low priority state. The priority signal is kept low also during the sleep periods of the WiMAX modem.

When there is only low priority service flow data reception allocated in a DL sub-frame, the priority signal may be set to indicate low priority after reception of the DL/UL map and possible DCD/UCD fields. However, the WiMAX modem may be controlled to receive data for the low priority service flows since it does not know if any interfering modem is transmitting data at that time. If there is interference, it will be noticed when doing an error checking/correction procedure for the received packet. If the UL subframe has only low priority service flow allocations, the WiMAX modem may be prevented from transmitting any data. Consequently, UL subframe period is signalled to be low priority for WiMAX. Thus, other radios may transmit or receive during that time.

The WiMAX standard defines three connections for link establishment and service flow creation purposes: basic connection, primary connection and secondary connection.

In one embodiment the apparatus is configured to define connections for WiMAX link establishment and service flow connections as high priority data and to generate the priority signal to the second communications unit to prevent transmission by the second communications unit during reception of data of these connections.

Also other WiMAX control data may be prioritized by the priority signal. In one embodiment ranging and contention request operations, for instance, are defined as high priority data.

It is possible that a WiMAX base station would never schedule low priority service flow traffic for the same frame as high priority traffic. This would then completely block the transmissions of the low priority service flow. To prevent this, in one embodiment a temporary priority modification is applied. The temporary priority modification may be implemented by service flow specific parameters. These parameters may define a number of omitted low priority frames, after which the priority of the link is temporarily set as high for a configurable amount of frames. Similarly, also some UL time for acknowledgements can be guaranteed by setting some UL sub-frames as high priority.

Above-illustrated WiMAX prioritization may be arranged by utilizing scheduling data received from the network. The multi-radio controller may receive or access such data and generate the priority signal accordingly.

In one embodiment the second communications unit is an IEEE 802.15 compliant transceiver, such as an IEEE 802.15.1 compliant Bluetooth transceiver. Such a Bluetooth transceiver hops following a known hopping pattern, but a prioritization controller in the transceiver may be configured to prevent BT transmission during reception of a priority signal indicating high priority for the data service flow of the other (first) communications unit. An exemplary WiMAX-BT co-existence use case is illustrated below.

First, the user opens a web browser which opens a service flow on a WiMAX radio. Later the user either calls or receives a VoIP call (over WiMAX) with a Bluetooth BT headset connected, i.e. the VoIP call is further routed by a BT transceiver in the mobile device to a BT headset. In this case the VoIP traffic over WiMAX is the most important link to the user. Next one, almost as important one, is the BT link since the user is routing the call to the headset. Lowest priority is the data link of WWW surfing.

If antenna isolation is not good enough, BT transmission causes interference to the WiMAX reception. If WiMAX is receiving WWW data, this is not a problem since the BT traffic is more important than the WWW data. But if this interference happens when WiMAX is receiving VoIP, the BT transmission will corrupt the voice call, which is not acceptable. Similarly, the WWW data transmission may corrupt BT traffic, which is also unacceptable. The corruption of BT traffic causes retransmissions on BT. There may be active WiMAX transmission ongoing at the beginning of the BT retransmission. This causes the retransmission to fail. If the WiMAX frame changes during the BT retransmission, reception of WiMAX DL/UL map may be corrupted. This is a bad situation, since the WiMAX modem has no idea of what is scheduled in the next DL and UL sub-frames and it has to discard them.

With the present prioritization method, the VoIP data can be configured as a high priority data service flow and the WWW data as a low priority data service flow. FIG. 5 illustrates a transmission example use case applying the present prioritization features. The reference 50 illustrates WiMAX transmissions; 51, 53 and 55 each include a preamble and DL/UL map of a WiMAX frame, 52 represents VoIP traffic with a high-priority priority class and 54 low-priority WWW traffic. 60 represents the priority signal from WiMAX to the BT. 70 represents BT transmissions; 71 represents planned BT transmission delayed 72 due to the priority signal indicating high priority; 73, 74 and 75 represent BT transmissions allowed during low-priority WiMAX periods.

By using the priority signal as illustrated above, co-existence of the BT and the WiMAX transceivers may be improved in two aspects: The BT does not attempt 71 any transmissions during the high priority WiMAX traffic and therefore will not cause interference to the VoIP traffic 52 or the UL/DL map 51 reception. Also, if the WiMAX is configured to prevent transmission on UL sub-frames for which only low priority traffic is scheduled, BT gets more space to operate. BT transmissions 73, 74 may still cause WWW data 54 corruptions, but this is acceptable as BT has higher priority.

Hence, by applying above-illustrated further improved co-existence features, it becomes possible to reduce unsuccessful transmissions and save power.

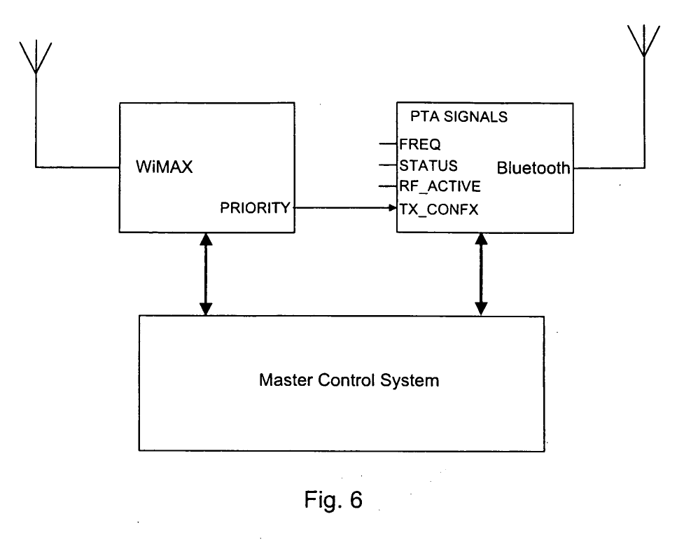

FIG. 6 illustrates an embodiment of a priority signaling implementation arrangement between WiMAX and BT modems. The WiMAX modem and the BT modem are controlled by a master control system. The WiMAX modem comprises a controller generating the priority signal and the priority signal is directly connected to the BT modem. In this embodiment a TX_CONFX signal of BT/WLAN co-existence interface (PTA) is applied to submit the priority signal between the WiMAX transceiver and the BT transceiver. This embodiment enables a simple co-existence mechanism between WiMAX and other radios and can even be utilized with current BT modems.

The above-illustrated priority signaling procedures may be utilized also for other radios, such as the IEEE 802.11 WLAN. WLAN transmission/reception may be controlled on the basis of the priority signal from a multi-radio controller, and/or a priority signal may be generated on the basis of WLAN data service flow priority classes. For instance, the WiMAX communications unit may send a priority signal, defined as illustrated above, which is detected also by a WLAN communications unit. If the mobile device has also a WLAN modem, an OR operation may be performed between the priority signal and the TX_CONFX signal of WLAN indicating its activity.

It will be obvious to a person skilled in the art that, as technology advances, the inventive concept can be implemented in various ways. The invention and its embodiments are not limited to the examples described above but may vary within the scope of the claims.

1. An apparatus, comprising:
a verifier configured to check a priority class for a data service flow transmitted or received by a first communicator;
a generator configured to selectively generate a priority signal for a second communicator to indicate prioritization for the first communicator on the basis of the checking; and
an adapter configured to adapt at least one of transmission and reception by the second communicator in response to the priority signal.

2. The apparatus of claim 1, wherein the generator is configured to generate a priority signal indicating low priority in response to detecting that there is no traffic scheduled or in response to a scheduled data service flow belonging to a priority class for non-delay sensitive traffic to allow the second communicator to perform at least one of transmitting and receiving in response to the priority signal indicating low priority.

3. The apparatus of claim 1, wherein apparatus is configured to prevent transmission by the first communicator in response to detecting a need to transmit low priority data by the first communicator.

4. The apparatus of claim 1, wherein the apparatus is arranged in the first communicator or separately coupled to the first communicator and the second communicator, the apparatus being configured to transmit the priority signal to the second communicator.

5. The apparatus of claim 1, wherein the apparatus comprises a first prioritization controller in the first communicator and a second prioritization controller in the second communicator, wherein
the first prioritization controller is configured to check the priority class, generate the priority signal, and transmit the priority signal to the second communicator, and
the second prioritization controller is configured to receive the priority signal and adapt at least one of the transmission and reception in response to the priority signal.

6. The apparatus of claim 1, wherein the verifier is configured to define connections for link establishment as high priority data service flows and wherein the generator is configured to generate the priority signal for the second communicator to prevent transmission by the second communicator during the defined connections.

7. The apparatus of claim 1, wherein the first communicator is a WiMAX transceiver and the second communicator is an IEEE 802.15 compliant transceiver.

8. The apparatus of claim 7, wherein the generator is configured to generate the priority signal to prevent transmission by the second communicator for reception of WiMAX downlink maps, uplink maps, downlink channel descriptor fields and uplink channel descriptor fields.

9. The apparatus of claim 6, wherein the verifier is configured to switch the priority signal to indicate low priority after the reception of the link establishment and service flow connection data and in response to no data or no high-priority data being scheduled for the data service flow.

10. The apparatus of claim 1, wherein the apparatus is a multiradio mobile station.

11. The apparatus of claim 1, wherein the verifier is further configured to check a connection identifier of each packet to be transmitted in a single data frame and define a priority class for each of the connection identifiers, and the generator is further configured to generate a priority signal to prioritize transmission of the data frame in accordance with a highest priority class.

12. A method, comprising:
checking a priority class for a data service flow transmitted or received by a first communicator;
generating a priority signal for a second communicator to indicate prioritization for the first communicator on the basis of the checking; and
adapting at least one of transmission and reception of the second communicator in response to the priority signal.

13. The method of claim 11, wherein a priority signal is generated to indicate low priority in response to detecting that there is no traffic scheduled or in response to a scheduled data service flow belonging to a priority class for non-delay sensitive traffic, allowing the second communicator to perform at least one of transmitting and receiving in response to the priority signal indicating low priority.

14. The method of claim 12, wherein transmission by the first communicator is prevented in response to detecting a need to transmit low priority data by the first communicator.

15. The method of claim 12, wherein a multi-radio controller is arranged in the first communicator or separately coupled to the first communicator and the second communicator, the multi-radio controller being configured to perform at least one of checking the priority class, generating the priority signal, and transmitting the priority signal to the second communicator.

16. The method of claim 12, wherein a first prioritization controller is provided in the first communicator and a second prioritization controller is provided in the second communicator, wherein
the first prioritization controller is configured to check the priority class, generate the priority signal, and send the priority signal to the second communicator, and
the second prioritization controller is configured to receive the priority signal and adapt at least one of the transmission and reception in response to the priority signal.

17. The method of claim 12, wherein connections for link establishment are defined as high priority data service flows and the priority signal is generated for the second communicator to prevent transmission by the second communicator during the defined connections.

18. The method of claim 12, wherein the first communicator is a WiMAX transceiver and the second communicator is an IEEE 802.15 compliant transceiver in a multi-radio mobile station.

19. The method of claim 18, wherein the priority signal is generated to prevent transmission by the second communicator for reception of WiMAX downlink maps, uplink maps, downlink channel descriptor fields and uplink channel descriptor fields.

20. The method of claim 17, wherein the multi-radio controller is configured to switch the priority signal to indicate low priority after the reception of the link establishment and service flow connection data and in response to no data or no high-priority data being scheduled for the data service flow.

21. A computer program embodied on a computer readable medium, the computer program causing a processor to perform:
checking a priority class for a data service flow transmitted or received by a first communicator,
generating a priority signal for a second communicator to indicate prioritization for the first communicator on the basis of the checking, and
adapting at least one of transmission and reception of the second communicator in response to the priority signal.

22. The computer program of claim 21, further causing the processor to perform:
preventing transmission by the first communicator in response to detecting a need to transmit low priority data by the first communicator.

23. An apparatus, comprising:
first communication means;
second communication means;
checking means for checking a priority class for a data service flow transmitted or received by the first communication means;
signal generation means for generating a priority signal for the second communication means to indicate prioritization for the first communication means on the basis of the checking; and
adaptation means for adapting at least one of transmission and reception of the second communication means in response to the priority signal.

24. The apparatus of claim 23, wherein the apparatus is configured to generate a priority signal indicating low priority in response to detecting that there is no traffic scheduled or in response to a scheduled data service flow belonging to the priority class for non-delay sensitive traffic, allowing the second communication means to perform at least one of transmitting and receiving in response to the priority signal indicating low priority.

25. An apparatus, comprising:
a verifier configured to check a priority class for a data service flow transmitted or received by a first communicator; and
a generator configured to selectively generate a priority signal for a second communicator on the basis of the checking, to indicate prioritization for the first communicator.

26. The apparatus of claim 25, wherein the apparatus is embodied in a chipset.

27. The apparatus of claim 25, wherein the generator is configured to generate a priority signal indicating low priority in response to detecting that there is no traffic scheduled or in response to a scheduled data service flow belonging to a priority class for non-delay sensitive traffic to allow the second communicator to perform at least one of transmitting and receiving in response to the priority signal indicating low priority.

28. The apparatus of claim 25, wherein the verifier is configured to define connections for link establishment as high priority data service flows and the generator is configured to generate the priority signal for the second communicator to prevent transmission by the second communicator during the defined connections.

29. The apparatus of claim 25, wherein the first communicator is a WiMAX transceiver and the second communicator is an IEEE 802.15 compliant transceiver.

30. The apparatus of claim 29, wherein the generator is configured to generate the priority signal to prevent transmission by the second communicator for reception of WiMAX downlink maps, uplink maps, downlink channel descriptor fields and uplink channel descriptor fields.

31. A method, comprising:
checking a priority class for a data service flow transmitted or received by a first communicator; and
selectively generating a priority signal for a second communicator on the basis of the checking, to indicate prioritization for the first communicator.

32. The method of claim 31, further comprising:
generating a priority signal indicating low priority in response to detecting that there is no traffic scheduled or in response to a scheduled data service flow belonging to a priority class for non-delay sensitive traffic to allow the second communicator to perform at least one of transmitting and receiving in response to the priority signal indicating low priority.

33. The method of claim 31, further comprising:
defining connections for link establishment as high priority data service flows; and
generating the priority signal for the second communicator to prevent transmission by the second communicator during the defined connections.

34. The method of claim 31, wherein the first communicator is a WiMAX transceiver and the second communicator is an IEEE 802.15 compliant transceiver.

35. The method of claim 34, wherein the priority signal is generated to prevent transmission by the second communicator for reception of WiMAX downlink maps, uplink maps, downlink channel descriptor fields and uplink channel descriptor fields.
